(19) United States
(12) Patent Application Publication
(10) Pub. No.: US 2015/0090163 A1
(43) Pub. Date: Apr. 2, 2015

(54) INTERIOR SAFE DOOR OVERLAYS

(71) Applicant: Rhino Metals, Inc., Caldwell, ID (US)

(72) Inventor: Donald Suggs, Boise, ID (US)

(21) Appl. No.: 14/500,558

(22) Filed: Sep. 29, 2014

Related U.S. Application Data
(60) Provisional application No. 61/883,908, filed on Sep. 27, 2013.

(51) Int. Cl. E05G 1/026; E05G 1/10; A47B 81/00; E05G 1/024

(52) U.S. Cl. CPC E05G 1/026; E05G 1/024; E05G 1/10; A47B 81/005
USPC 109/24; 109/64; 109/82

(57) ABSTRACT

Overlays for the interior of safe doors, such as doors of metal gun safes. In some embodiments, the safe may comprise a door frame comprising an interior surface. A door backing may be coupled to the interior surface of the door frame. A sheet of material may be coupled to the door backing, and an overlay may be positioned to extend along one or more edges of the interior surface of the door frame such that at least a portion of the sheet of material is positioned between the overlay and the door backing. Such configurations may allow for utilization of the interior of the safe door for storage of various items, such as firearm ammunition and other accessories, and further may simplify the process of manufacturing such accessories and/or improve the appearance of the interior of the door.

### RELATED APPLICATIONS

This application claims the benefit under 35 U.S.C. §119(e) of U.S. Provisional Patent Application No. 61/883,908 filed Sep. 27, 2013 and titled “INTERIOR SAFE DOOR OVERLAYS,” which application is incorporated herein by reference in its entirety.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a side elevation view of a safe door according to one embodiment.

FIG. 2 is a front elevation view of the interior surface of the safe door of FIG. 1.

FIG. 3 is a cross-sectional view taken along line 3-3 of FIG. 2.

FIG. 4 is a side elevation view of a safe door according to another embodiment.

### DETAILED DESCRIPTION

A detailed description of apparatus, systems, and methods consistent with various embodiments of the present disclosure is provided below. It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In addition, while numerous specific details are set forth in the following description in order to provide a thorough understanding of the embodiments disclosed herein, some embodiments can be practiced without some or all of these details. Moreover, for the purpose of clarity, certain technical materials, structures, or operations that are known in the related art have not been shown or described in detail in order to avoid unnecessarily obscuring the disclosure.

Various embodiments of apparatus, methods, and systems are disclosed herein that relate to overlays for safe doors. In some embodiments, the safes may be specifically configured for storing guns or other weapons. As discussed in greater detail below, in some embodiments, the overlays may be used to protect one or more edges and/or corners of an interior door backing for a safe. Some embodiments may also, or alternatively, be configured to allow for tucking, hiding, binding, and/or storing a peripheral edge of a sheet placed on such a door backing, which sheet may be used to provide one or more storage structures, such as pockets, pouches, straps, and the like. Some embodiments may also, or alternatively, be configured to allow for placement of one or more auxiliary/accessory items on the interior of the safe door, such as lights, electronic devices, hooks, trays, drawers, clamps, straps, alarms, speakers, or a fabric panel that may comprise pockets, pouches, straps, etc.

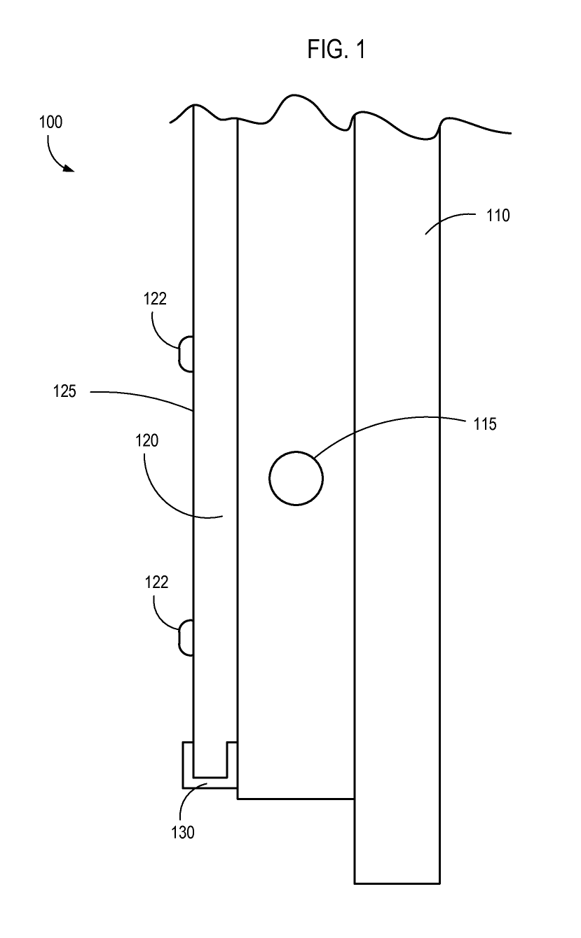

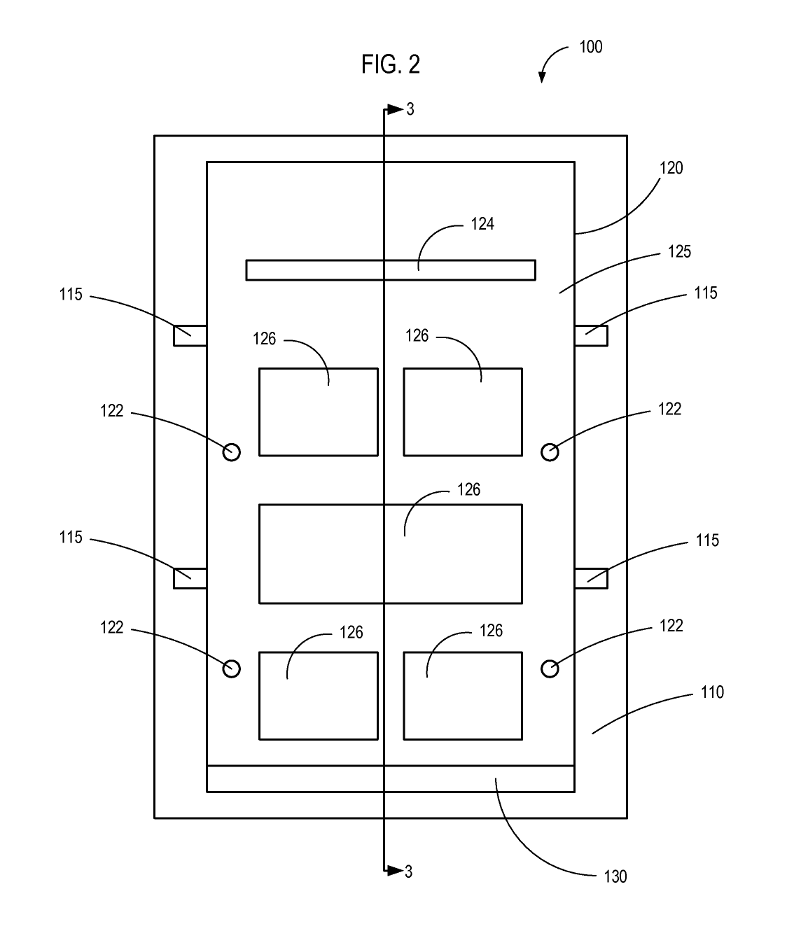

Certain embodiments of safes and safe doors incorporating such overlays will now be discussed in greater detail with reference to the accompanying drawings. FIG. 1 is a side view depicting an embodiment of a safe door 100. FIG. 2 is a front view of the inside surface of safe door 100. In other words, FIG. 2 depicts what a user would see on safe door 100 upon unlocking and opening an associated safe.

Safe door 100 may, for example, be used as a door for a gun safe, or any other type of safe or other locking enclosure as desired. Safe door 100 comprises a door frame 110 and may further comprise one or more locking bolts 115. Safe door 100 may further comprise an interior door backing 120. Door backing 120 may be used to affix one or more items to an interior surface of a door, as discussed below, or may simply be used to provide an aesthetically pleasing appearance to the interior of the door by, for example, allowing for placement of fabric or other sheets of material on the interior door surface. Door backing 120 may comprise, in some embodiments, sheetrock. Other examples of suitable materials for door backing 120 include wood, vinyl, and the like.

One or more fasteners 122 may be used to attach door backing 120 to door frame 110. Fasteners 122 may comprise, for example, machine screws with washers, bolts, rivets, hooks, nails, etc. In some embodiments, fasteners 122 may be removable or may otherwise allow for removing door backing 120 to allow for replacing door backing 120 with a newer door backing and/or one having a different style and/or function. For example, in some embodiments, fasteners may be permanently attached to door frame 110 but may allow for a door backing 120 to be placed on the fasteners 122 and easily removed from fasteners 122 to allow for replacement of door backing 120. In other embodiments, door backing 120 may be attached to door frame 110 using an adhesive. In some such embodiments, fasteners 122 may therefore be absent.

Door 100 may further comprise an overlay 130 extending about at least a portion of a peripheral edge of door backing 120. In the depicted embodiment, overlay 130 comprises a protective overlay. Protective overlay 130 extends across the entire length of the bottom edge of door backing 120, as shown in the view of FIG. 2. However, other embodiments are contemplated in which protective overlay 130 extends about other edges of the door backing 120. In some embodiments, protective overlay may extend about the entire perimeter edge of door backing 120.

Protective overlay 130 may serve a number of different purposes. For example, protective overlay 130 may be used to protect the corners and/or edges of door backing 120, which may be particularly useful in embodiments comprising a door backing made up of a material that may be easily damaged, and particularly so along the corners and/or edges of the door backing, such as sheetrock. Protective overlay 130 may also be used to “tuck in,” attach, or otherwise obscure a sheet 125 of material that may be attached to or otherwise coupled with the door backing 120, as discussed in greater detail below. In some embodiments, protective overlay 130 may also be used to facilitate attachment of one or more elements to an interior surface of a safe door, such as lights, electric devices, hooks for keys and the like, trays to hold bullets or other items, etc. In some embodiments, overlay 130 may also, or alternatively, be used to store wiring (for example, wiring for an electric dehumidifier rod) for various electronic items provided and/or used with the safe. In some such embodiments, one or more internal channels may be built into the overlay to allow for extending wiring and/or other electronics, for example, therethrough. Alternatively, such channel(s) may be configured to receive a fire seal, such as an intumescent, therethrough.

Protective overlay 130 may comprise any number of suitable materials, such as extruded plastic, aluminum, steel, fabric, tape, wood, fiberglass, Kevlar, cardboard, masonite, or a hardening liquid. In some embodiments, protective overlay 130 is coupled with door backing 120 such that a space is provided between protective overlay 130 and door backing 120 so as to allow for a material, such as sheet 125, to be tucked in or otherwise positioned between door backing 120 and protective overlay 130. This may be useful for a number of different reasons. For example, this may prevent the edges of sheet 125 from fraying or otherwise degrading over time. In addition, this may allow for attachment of sheet 125 to door backing 120 without the need for wrapping sheet 125 all of the way around door backing 120 and/or attaching sheet 125 to a rear surface of door backing 120. In some embodiments, overlay 130 may also be used to attach sheet 125 to door backing 120 without need for any additional fasteners.

In some embodiments, however, protective overlay 130, or another similar overlay, may be applied without providing this intermediate spacing. For example, in some embodiments, an overlay may be applied directly to a sheet 125 or door backing 120 such that sheet 125 is positioned in between the overlay and the door backing tightly without providing for any appreciable space between overlay 130 and the sheet 125 and/or door backing 120.

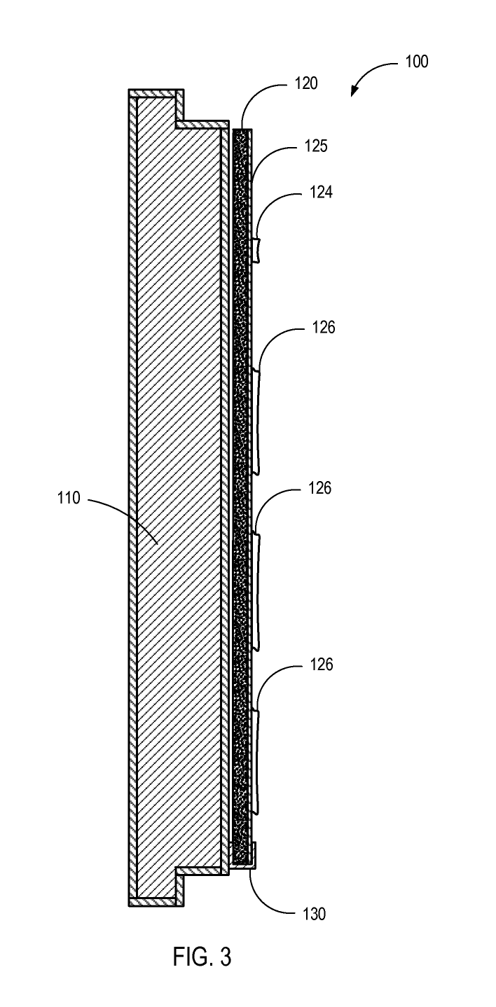

FIG. 3 is a cross-sectional view taken from line 3-3 in FIG. 2. As best seen in this figure, sheet 125 is attached to an exterior surface of door backing 120. Sheet 125 may comprise, for example, a cloth material, a nylon material, a vinyl material, or any other such suitable material available to one of ordinary skill in the art. In some embodiments, sheet 125 may comprise a material of sufficient strength and durability to allow for mounting or otherwise supporting the weight of various guns and/or gun accessories. Sheet 125 may be attached or otherwise coupled with door backing 120 by any number of suitable means, including, for example, adhesives, staples, nails, screws, bolts, tacks, and the like.

As shown in FIGS. 2 and 3, sheet 125 may comprise one or more means for storing guns and/or gun accessories, such as bullets. For example, in the depicted embodiment, safe door 100 comprises a strap 124 and a plurality of pouches 126, both of which are examples of means for storing guns and/or gun accessories. In some embodiment, these storing means may be removably attached to sheet 125, such as, for example, by way of hook and loop fasteners. In other embodiments, such storing means may be permanently coupled with sheet 125. In some such embodiments, the storing means may be an integral part of sheet 125 or otherwise made from the same material as sheet 125.

As also best seen in FIG. 3, overlay 130 comprises a U shape in cross section. As such, overlay 130 comprises a first surface covering and adjacent to an outer surface of sheet 125 (which itself covers door backing 120), a second surface adjacent to a lower surface of door backing 120, and a third surface adjacent to a rear surface of door backing 120, with each of the three surfaces being perpendicular to its respective adjacent surface(s).

Thus, some embodiments may be particularly configured such that sheet 125 does not extend beyond a bottom edge (or, in some such embodiments, beyond any edge) of door backing 120. In some embodiments, safe door 100 may be configured such that sheet 125 is not wrapped around the bottom edge (or, in some such embodiments, bottom, top, and side edges) of door backing 120. Thus, by providing one or more overlays 130, as described herein, a sheet, such as sheet 125, may be coupled with a safe door (such as, in the depicted embodiment, by coupling sheet 125 with door backing 120) without the need for increasing the size of the sheet beyond the perimeter of the door and/or door backing, without wrapping the sheet around and/or behind the door and/or door backing, and, in some embodiments, without the need for additional fasteners. Such overlay(s) may also provide an improved appearance and/or may be used to provide for additional accessories and/or storage features, as described elsewhere herein.

Of course, other embodiments are contemplated in which sheet 125 may be partially tucked behind door backing 120. Thus, overlay 130 may be positioned such that a first surface of overlay 130 is positioned adjacent to an outer surface of sheet 125, such that a second surface of overlay 130 is positioned adjacent to a lower surface of at least one of sheet 125 and door backing 120, and such that a third surface of overlay 130 is positioned adjacent to a rear surface of at least one of sheet 125 and door backing 120. In some embodiments, one surface of door backing 120 may be positioned in between door frame 110 and door backing 120. Alternatively, this surface of door backing 120 may be positioned in between sheet 125 and door frame 110.

Although overlay 130 comprises a U-shaped overlay, other overlays are contemplated having various different shapes and sizes as desired. For example, some embodiments may comprise an L-shaped (in cross section) overlay such that only two edge surfaces of the door backing and/or sheet are covered. Still other embodiments may comprise a flat panel that only covers one such surface. In addition, some embodiments may comprise overlays, of any of the aforementioned shapes, that cover more, or less, of the edge surfaces of the door backing 120 and/or sheet 125 than are depicted in the embodiment of FIGS. 1-3.

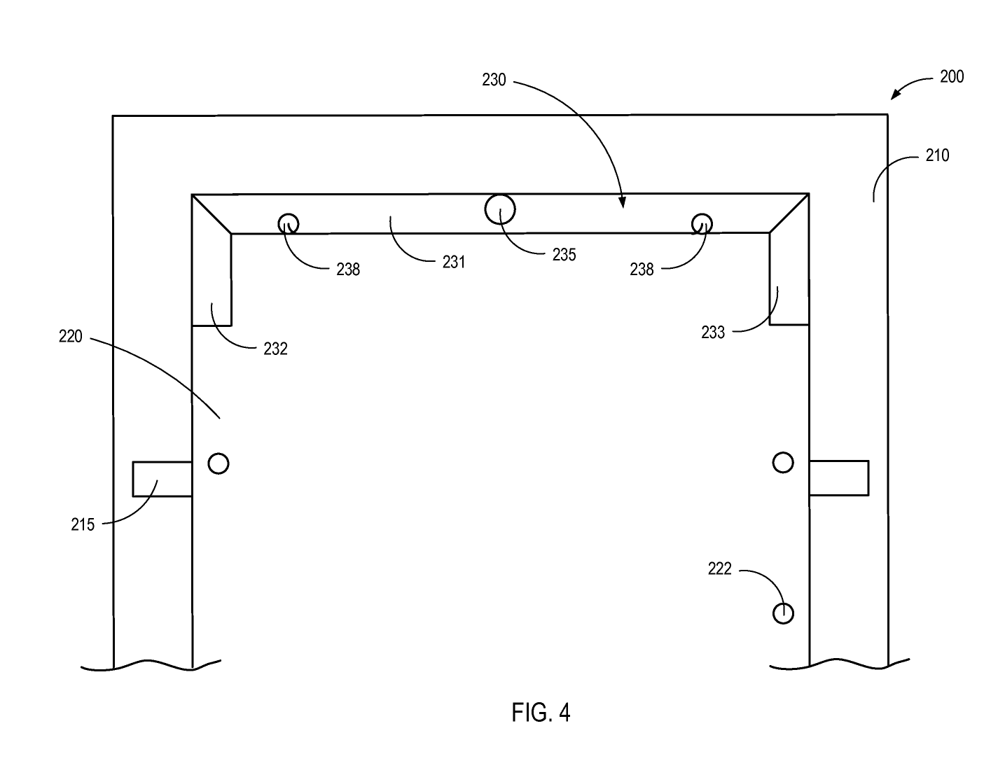

For example, FIG. 4 depicts an alternative embodiment of a safe door 200 shown from the interior surface of the door. Like safe door 100, safe door 200 comprises a door frame 210 and one or more locking bolts 215 for securing the safe door 200 in a closed position. Safe door 200 further comprises an interior door backing 220 coupled with door frame 210 by way of fasteners 222.

Safe door 200 also comprises an overlay 230. However, unlike overlay 130, overlay 230 covers the entire top edge of door backing 220, and also partially covers two side edges of door backing 220. In alternative embodiments, overlay 130 may fully cover the two side edges of door backing 220 and/or may cover the bottom edge of door backing 220, either partially or fully. In some embodiments, multiple overlays may be used. For example, in some embodiments, a separate overlay may be positioned on each edge, or a subset of the edges, of the door backing.

Any of the overlays described herein, including overlays 130 and 230, may comprise, for example, one or more of plastic (extruded, vacuum-formed, or injection-molded plastic, for example), aluminum, steel, fabric, tape, wood, fiberglass, Kevlar, cardboard, masonite, or a hardening liquid. Such overlays may be coupled with the safe door using any number of suitable means/methods. For example, in some embodiments, the overlays may be configured to snap onto a door backing.

In some such embodiments, the overlay may comprise a flexible, resilient plastic material configured to flex open to receive one or more edges of a door backing and then automatically flex back into a smaller shape such that the door backing firmly grips the edge(s) of the door backing. In some embodiments, screws, pins, nails, tacks, staples, and/or adhesives may be used to couple one or more overlays to one or more portions of a safe door backing.

In some embodiments, the overlay may comprise a plurality of overlay portions. In some such embodiments, two or more such overlay portions may be configured to fit together or otherwise extend adjacent to one another. For example, some embodiments may comprise a separate overlay portion for each of the four (or a subset of the four) edges of the door backing. Some embodiments may further comprise separate corner overlay portions each configured to cover a single corner and adjoining edges of the door backing.

For example, overlay 230 depicted in FIG. 4 comprises three overlay portions—overlay portions 231, 232, and 233—each of which is positioned adjacent to one or more other overlay portions. Overlay portions 231, 232, and 233 may each be separate pieces that together make up overlay 230. Alternatively, overlay portions 231, 232, and 233 may comprise portions of a single, unitary overlay 230.

It can also be seen in FIG. 4 that overlay 230 comprises several auxiliary pieces, namely, auxiliary pieces 235 and 238, that provide additional function to the interior surface of safe door 200. Auxiliary piece 235 comprises an interior light. Interior light 235 may be wireless or may comprise one or more wires that may be extended to a power source. In such embodiments, overlay 230 may comprise a channel on an interior surface to allow for threading such wiring therethrough. In some embodiments, interior light 235 may be coupled with a switch and/or sensor that automatically turns the light on when safe door 200 is in an open position.

Auxiliary pieces 238 may comprise hooks, which may be used to hang various items, such as hunting gear, bags, packs, pistol holsters, panels of pockets or pouches, webbings, straps, and the like. Other examples of auxiliary pieces that may be positioned on and/or within one or more portions of overlay 230 include trays (in some embodiments, removable trays that may be configured to fits within a groove in the overlay 230), clips, holders for cleaning rods, fire protection or heat transfer limiting chemicals, liquids, or devices, drawers, clamps, straps, alarms and/or speakers for an alarm system, and the like.

As mentioned above, some embodiments may comprise a sheet of fabric or other material that may be positioned over a door backing. In some such embodiments, particularly in such embodiments in which at least the top edge of the door backing is covered with an overlay, the overlay may also be used to affix the sheet to the door backing if desired. For example, if staples, nails, bolts, screws, or other fasteners are used to attach the overlay, such fasteners may also extend through the door backing such that no additional means for attaching the sheet to the overlay are necessary. Of course, in other embodiments, fasteners may extend through the overlay and sheet, and other fasteners, adhesives, or other attachment means may still be used to specifically attach the sheet to the door backing if desired. In some embodiments, the overlay may be configured to be coupled with the door frame rather than the door backing. In some such embodiments, for example, the overlay may comprise a tab, slot, or part of an interlocking flange to allow for coupling the overlay to the door and thereby coupling the door backing to the door at the same time.

In some such embodiments, the door frame may be configured with a corresponding groove, slot, tab, flange, etc., to further facilitate such coupling. For example, a groove may be formed in one or more portions of the door frame and the overlay may comprise a clip, flange, or tab configured to be received in the groove to clamp or otherwise hold a door backing therebetween.

It will be understood by those having skill in the art that changes may be made to the details of the above-described embodiments without departing from the underlying principles presented herein. For example, any suitable combination of various embodiments, or the features thereof, is contemplated.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. The scope of the present invention should, therefore, be determined only by the following claims.

1. A safe, comprising:
a door, wherein the door comprises:
a door frame comprising an interior surface;
a door backing coupled to the interior surface of the door frame;
a sheet of material coupled to the door backing; and
an overlay extending along a lower peripheral edge of the interior surface of the door frame such that at least a portion of the sheet of material is positioned between the overlay and the door backing.

2. The safe of claim 1, wherein the overlay comprises a U shape in cross section.

3. The safe of claim 1, wherein the overlay comprises an L shape in cross-section.

4. The safe of claim 1, wherein the safe comprises a metal safe, and wherein the door frame comprises a metal material.

5. The safe of claim 1, wherein the overlay extends about an entire perimeter of the interior surface of the door frame.

6. The safe of claim 1, wherein the overlay further comprises at least one internal channel configured to allow for at least one of wiring and a fire seal to extend therethrough.

7. The safe of claim 1, further comprising an accessory coupled with the overlay such that the overlay facilitates coupling of the accessory with the door, wherein the accessory comprises at least one of a light, a hook, a tray, a drawer, an alarm, a strap, a speaker, and a fabric panel.

8. The safe of claim 1, wherein the sheet of material is coupled to the door backing without wrapping the sheet of material behind the door backing.

9. The safe of claim 8, wherein the sheet of material is coupled to the door backing without extending the sheet of material beyond any edge of the door backing.

10. A metal safe, comprising:
a door, wherein the door comprises:
a door frame comprising a metal, wherein the door frame comprises an interior surface; and
at least one overlay extending over at least a portion of a peripheral edge of the interior surface of the door frame such that the at least a portion of the peripheral edge is obscured by the overlay.

11. The metal safe of claim 10, wherein the at least one overlay extends over at least a portion of a lower edge of the interior surface of the door frame.

12. The metal safe of claim 11, wherein the at least one overlay extends over the entire length of the lower edge of the interior surface of the door frame.

13. The metal safe of claim 10, further comprising a door backing coupled to the interior surface of the door frame.

14. The metal safe of claim 13, wherein the at least one overlay is positioned adjacent to at least a portion of a peripheral edge of the door backing.

15. The metal safe of claim 14, further comprising a sheet coupled to the door backing.

16. The metal safe of claim 15, wherein the sheet is directly coupled to the door backing.

17. The metal safe of claim 15, wherein the sheet comprises means for storing at least one of a firearm and a firearm accessory.

18. The metal safe of claim 17, wherein the means for storing at least one of a firearm and a firearm accessory comprises at least one of a pouch, a strap, and a pocket.

19. The metal safe of claim 17, wherein the means for storing at least one of a firearm and a firearm accessory is configured to be removably coupled with the sheet.

20. The metal safe of claim 10, wherein the at least one overlay comprises a plurality of overlays, wherein at least one of the plurality of overlays extends along at least a portion of a first peripheral edge of the interior surface of the door frame, and wherein at least one of the plurality of overlays extends along at least a portion of a second peripheral edge of the interior surface of the door frame.

21. A metal gun safe, comprising:
a metal door frame comprising an interior surface, wherein the interior surface comprises a lower peripheral edge;
a door backing coupled to the interior surface of the metal door frame, wherein the door backing comprises at least one of sheet rock, wood, and a plastic;
a plurality of fasteners positioned to couple the door backing to the metal door frame;
a sheet coupled to the door backing, wherein the sheet comprises a lower peripheral edge, and wherein the sheet comprises at least one of a cloth material, a nylon material, a carpet, a felt material, and a plastic;
means for storing at least one of a firearm and a firearm accessory; and
an overlay extending over the entire length of the lower peripheral edge of the interior surface of the metal door frame such that the entire length of the lower peripheral edge of the sheet is positioned between the overlay and the door backing, wherein the overlay comprises a U shape in cross section, and wherein the overlay is positioned such that a first surface of the overlay is positioned adjacent to an outer surface of the sheet, such that a second surface of the overlay is positioned adjacent to a lower surface of at least one of the sheet and the door backing, and such that a third surface of the overlay is positioned adjacent to a rear surface of at least one of the sheet and the door backing.

22. The metal gun safe of claim 21, wherein the means for storing at least one of a firearm and a firearm accessory is positioned on the overlay.
